(19) United States
(12) Patent Application Publication
(10) Pub. No.: US 2026/0104521 A1
(43) Pub. Date: Apr. 16, 2026

(54) Fiber-optic transmission-based real-time ocean bottom seismic node

(71) Applicant: Institute of Geology and Geophysics, Chinese Academy of Sciences, Beijing (CN)

(72) Inventors: Yuan WANG, Beijing (CN); Chunlei ZHAO, Beijing (CN); Lei YANG, Beijing (CN)

(73) Assignee: Institute of Geology and Geophysics, Chinese Academy of Sciences, Beijing (CN)

(21) Appl. No.: 19/287,851

(22) Filed: Aug. 1, 2025

(30) Foreign Application Priority Data
Oct. 15, 2024 (CN) 202411436653.4

(51) Int. Cl. G01V 1/22; G01V 1/28

(52) U.S. Cl. CPC G01V 1/226; G01V 1/28; G01V 2210/32

(57) ABSTRACT

A fiber-optic transmission-based real-time ocean bottom seismic node includes: a seismic acquisition compartment and a battery compartment, where the seismic acquisition compartment includes a seismometer compartment body, a compressed O-ring, and a seismometer compartment sealing cover; an airtight space is formed inside the seismometer compartment body by the seismometer compartment sealing cover via the compressed O-ring; a bottom of the seismometer compartment body is provided with a three-component seismometer for acquiring ocean bottom seismic data, and a top of the seismometer compartment body is provided with an optical-electrical conversion connector; the three-component seismometer communicates with a fiber-optic trunk cable of a user terminal via the optical-electrical conversion connector; and the battery compartment is detachably connected to the seismic acquisition compartment and configured to supply power to the three-component seismometer. In the instrument, the three-component seismometer is connected to the user terminal via an optical fiber for high-speed data transmission.

### CROSS REFERENCE TO THE RELATED APPLICATIONS

This application is based upon and claims priority to Chinese Patent Application No. 202411436653.4, filed on Oct. 15, 2024, the entire contents of which are incorporated herein by reference.

### TECHNICAL FIELD

The present disclosure relates to the technical field of marine seismic observation, and in particular to a fiber-optic transmission-based real-time ocean bottom seismic node.

### BACKGROUND

Amid frequent global seismic activities and intensifying marine resource exploitation, the demand for ocean bottom seismic monitoring is rising significantly. Currently, marine seismic scientific research, marine geological engineering, ocean bottom oil-gas exploitation, and maritime defense security absolutely require real-time ocean bottom seismic observation. For instance, monitoring seismic activities of ocean bottom active faults employs an ocean bottom seismometer (OBS) capable of real-time data transmission to conduct studies on earthquake localization, focal mechanisms, focal rupture processes, and seismic imaging in fault zones. This substantially improves the precision of research outcomes, enhances monitoring and early warning capabilities for active faults, and provides first-hand data and determination basis for marine engineering projects (e.g., nuclear power plant operation safety monitoring, offshore wind farm safety and lifespan assessment, and ocean bottom pipeline operation assurance). During offshore oil-gas extraction, it is necessary to monitor the fracturing fluid migration front in real time through microseismic localization methods for real-time adjustment of fracturing zones. Real-time ocean bottom seismic detection equipment can delineate microseismic source locations in real time, providing prior positional information for real-time adjustment of fracturing operations in offshore oil-gas extraction.

The traditional non-real-time self-floating OBS adopts a working mode combining free-fall deployment from the sea surface and acoustic command-controlled retrieval. It can be deployed in any ocean bottom area to conduct ocean bottom seismic data acquisition over months or longer periods based on research vessel schedules. The observation data exhibits non-real-time characteristics and can only be accessed after successful retrieval of the OBS. However, the traditional self-floating OBS demonstrates notable deficiencies in real-time performance, data acquisition/processing efficiency, and monitoring continuity. Therefore, it is highly desirable to develop a more advanced OBS to overcome these deficiencies and enhance the efficiency and reliability of ocean bottom seismic monitoring.

### SUMMARY

To address the above-mentioned problems, an objective of embodiments of the present disclosure is to provide a fiber-optic transmission-based real-time ocean bottom seismic node.

A fiber-optic transmission-based real-time ocean bottom seismic node includes:
a seismic acquisition compartment, including a seismometer compartment body 18, a compressed O-ring 17, and a seismometer compartment sealing cover 16, where an airtight space is formed inside the seismometer compartment body 18 by the seismometer compartment sealing cover 16 via the compressed O-ring 17; a bottom of the seismometer compartment body 18 is provided with a three-component seismometer for acquiring ocean bottom seismic data, and a top of the seismometer compartment body 18 is provided with an optical-electrical conversion connector 11; and the three-component seismometer communicates with a fiber-optic trunk cable of a user terminal via the optical-electrical conversion connector 11; and
a battery compartment, detachably connected to the seismic acquisition compartment and configured to supply power to the three-component seismometer.

Preferably, a top protective cover 8 is fixed to the seismometer compartment sealing cover 16; the seismometer compartment sealing cover 16 is provided with a plurality of accessory mounting holes; and the optical-electrical conversion connector 11, a hydrophone 7, a data cable bulkhead penetrator 10, and a seismometer compartment air valve 9 are fixed to the seismometer compartment sealing cover 16 via the accessory mounting holes.

Preferably, the battery compartment includes a battery compartment upper cover 23, a battery compartment base 27, and a battery compartment body 24; the battery compartment upper cover 23 and the battery compartment base 27 compress sealing rings at two ends of the battery compartment body 24 respectively to form an airtight space inside the battery compartment body 24; and a rechargeable battery 26 is disposed inside the battery compartment body 24.

Preferably, an insulating filling liquid 25 is filled around the rechargeable battery 26 to resist an external pressure.

Preferably, the seismic acquisition compartment is fixed to a top surface of the battery compartment upper cover 23 via a bottom triangular positioning plate 14; and a buoyancy material 1 is disposed around the seismic acquisition compartment.

Preferably, the battery compartment is further provided with a battery compartment air valve 13.

Preferably, there is at least one battery compartment; and battery compartments are detachably connected to each other via a battery compartment connecting screw 15.

Preferably, the fiber-optic transmission-based real-time ocean bottom seismic node further includes:
a noise denoising module, configured to denoise the acquired ocean bottom seismic signal data and obtain denoised ocean bottom seismic signal data;
the noise denoising module includes:

a signal decomposition module, configured to perform wavelet transform on the ocean bottom seismic signal data to obtain a wavelet coefficient;
a threshold construction module, configured to calculate a denoising threshold based on a mean of the wavelet coefficient;
a processing function construction module, configured to construct a wavelet coefficient processing function based on the denoising threshold;
a thresholding module, configured to apply the wavelet coefficient processing function to the wavelet coefficient for thresholding to obtain a denoised wavelet coefficient; and
a denoising module, configured to reconstruct the denoised wavelet coefficient and obtain the denoised ocean bottom seismic signal data.

Preferably, in the threshold construction module, the denoising threshold is constructed as follows:

$$\{ \begin{matrix}\frac{{( {w}_{i , j - μ} )}^{2}}{{2}_{σ}^{2}} \\ {T}_{j} = ke \\ {D}_{j} = \frac{{σ}_{0}^{2}}{σ}\end{matrix}$$

where, Tⱼ denotes a denoising threshold at a j-th decomposition scale; k denotes a preset parameter; w_{i,j} denotes a j-th wavelet coefficient at an i-th decomposition scale; μ denotes a mean of the wavelet coefficient at the i-th decomposition scale; σ denotes a standard deviation of the j-th wavelet coefficient at the i-th decomposition scale, σ₀=median(|w_{i,j}|)/0.6745; and median denotes a median of the wavelet coefficient at the i-th decomposition scale.

Preferably, in the thresholding module, the wavelet coefficient processing function is:

$${\hat{w}}_{j , k} = \{ \text{} \begin{matrix}{w}_{j , k} - \frac{{T}_{j} ( α - {e}^{- β \frac{\vert {w}_{j , k} \vert - {T}_{i}}{{T}_{j}} )} sign ( {w}_{j , k} )}{α + {e}^{- β \frac{\vert {w}_{j , k} \vert - {T}_{j}}{{T}_{j}}}} & \vert {w}_{j , k} \vert > {T}_{j} ( 1 - \frac{In α}{β} ) \\ {w}_{j , k} - \frac{{T}_{j} ( α + 1 ) ( α - {e}^{- β \frac{\vert {w}_{j , k} \vert - {T}_{j}}{{T}_{j}}} ) sign ( {w}_{j , k} )}{( α - 1 ) ( α + {e}^{- β \frac{\vert {w}_{j , k} \vert - {T}_{j}}{{T}_{j}}} )} & {T}_{j} < \vert {w}_{j , k} \vert \leq {T}_{j} ( 1 - \frac{In α}{β} ) \\ 0 & \vert {w}_{j , k} \vert \leq {T}_{j}\end{matrix}$$

where, ŵ_{j,k} denotes the denoised wavelet coefficient; w_{j,k} denotes a k-th wavelet coefficient at the j-th decomposition scale; α denotes a first adjustable coefficient; and β denotes a second adjustable coefficient.

According to the specific embodiments provided in the present disclosure, the present disclosure discloses the following technical effects:

The present disclosure relates to a fiber-optic transmission-based real-time ocean bottom seismic node. Compared with the prior art, in the present disclosure, the three-component seismometer is connected to the user terminal via an optical fiber for high-speed data transmission, ensuring real-time transmission of seismic data to the user terminal, and facilitating long-term monitoring by researchers.

In order to make the above purposes, features, and advantages of the present disclosure clearer and more understandable, the present disclosure is described in detail below using preferred embodiments with reference to the drawings.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show merely some embodiments of the present disclosure, and a person of ordinary skill in the art may still derive other drawings from these drawings without creative efforts.

FIG. 1 is an overall structural schematic diagram of a fiber-optic transmission-based real-time ocean bottom seismic node according to the present disclosure;

FIG. 2 is an external overall schematic diagram of a combined high-sensitivity ocean bottom monitoring device according to the present disclosure;

FIG. 3 is an overall schematic diagram of the fiber-optic transmission-based real-time ocean bottom seismic node with a buoyancy material removed according to the present disclosure;

FIG. 4 is a cross-sectional view of a seismometer compartment of the fiber-optic transmission-based real-time ocean bottom seismic node according to the present disclosure; and

FIG. 5 is a cross-sectional view of a battery compartment of the fiber-optic transmission-based real-time ocean bottom seismic node according to the present disclosure.

### REFERENCE NUMERALS

1. buoyancy material; 2. lifting ring; 3. first battery compartment; 4. power supply bulkhead penetrator; 5. second battery compartment; 6. pull ring; 7. hydrophone; 8. top protective cover; 9. seismometer compartment air valve; 10. data cable bulkhead penetrator; 11. optical-electrical conversion connector; 12. compartment fixing screw; 13. battery compartment air valve; 14. triangular positioning plate; 15. battery compartment connecting screw; 16. seismometer compartment sealing cover; 17. O-ring; 18. seismometer compartment body; 19. acquisition circuit board; 20. optical-electrical conversion module; 21. geophone; 22. rechargeable battery; 23. battery compartment upper cover; 24. battery compartment body; 25. insulating filling liquid; 26. rechargeable battery; and 27. battery compartment base.

### DETAILED DESCRIPTION OF THE EMBODIMENTS

It should be understood that, in the description of the present disclosure, the terms such as “central”, “longitudinal”, “transverse”, “long”, “wide”, “thick”, “upper”, “lower”, “front”, “back”, “left”, “right”, “vertical”, “horizontal”, “top”, “bottom”, “inner”, “outer”, “clockwise” and “anticlockwise” are intended to indicate orientations shown in the drawings. It should be noted that these terms are merely intended to facilitate a simple description of the present disclosure, rather than to indicate or imply that the mentioned apparatus or elements must have the specific orientation or be constructed and operated in the specific orientation. Therefore, these terms may not be construed as a limitation to the present disclosure.

In addition, the terms such as “first” and “second” are used only for descriptive purposes, and should not be construed as indicating or implying relative importance or implying the number of indicated technical features. Thus, features defined with “first” and “second” may explicitly or implicitly include one or more of the features. In the description of the present disclosure, unless otherwise specifically defined, “a plurality of” means two or more.

In the present disclosure, unless otherwise clearly specified and limited, the terms “installed”, “connected with”, “connected to”, and “fixed” should be understood in a board sense. For example, the connection may be a fixed connection, a detachable connection or an integrated connection, may be a mechanical connection or an electrical connection, may be a direct connection or an indirect connection with use of an intermediate medium, or may be intercommunication between two components. Those of ordinary skill in the art may understand specific meanings of the above terms in the present disclosure based on a specific situation.

In structural design, an ocean bottom seismic node of the present disclosure adopts a dual-independent structure including an independent seismic acquisition compartment and an independent battery compartment body. The two independent compartment bodies are hard-connected by screws. The entire apparatus provides partial buoyancy through optimized configuration of a quantitative buoyancy material to ensure controllable underwater weight during deployment and retrieval. The independent seismic acquisition compartment includes a seismometer core and an acquisition circuit. The seismometer is a three-component high-sensitivity mechanical seismometer. The seismic acquisition compartment is fixedly connected to the independent battery compartment below. The quantity of the independent battery compartment is determined according to required seabed observation duration. A single battery compartment is designed with one-month battery capacity, and a plurality of battery compartments can be stacked and synchronously connected for multi-month observation. The independent seismometer compartment reserves a fiber optic interface, which can be quickly integrated with an external fiber optic cable through plug-and-play design for real-time data transmission. The independent seismic acquisition compartment body features compact size, light weight, and multi-purpose applications, with a conical buoyancy material externally arranged. The overall buoyancy of the instrument is freely selected according to the weight of the combined battery compartment and the volume and shape of the buoyancy material to ensure that the underwater weight does not exceed 5 kg. The seismic acquisition compartment is machined from a monolithic titanium alloy material, featuring light weight, high strength, and strong corrosion resistance. The independent battery compartment is made of 316 stainless steel filled with an insulating liquid, characterized by light weight and high energy density. When instrument retrieval is required, the instrument is dragged to a sea surface along a cable to complete retrieval.

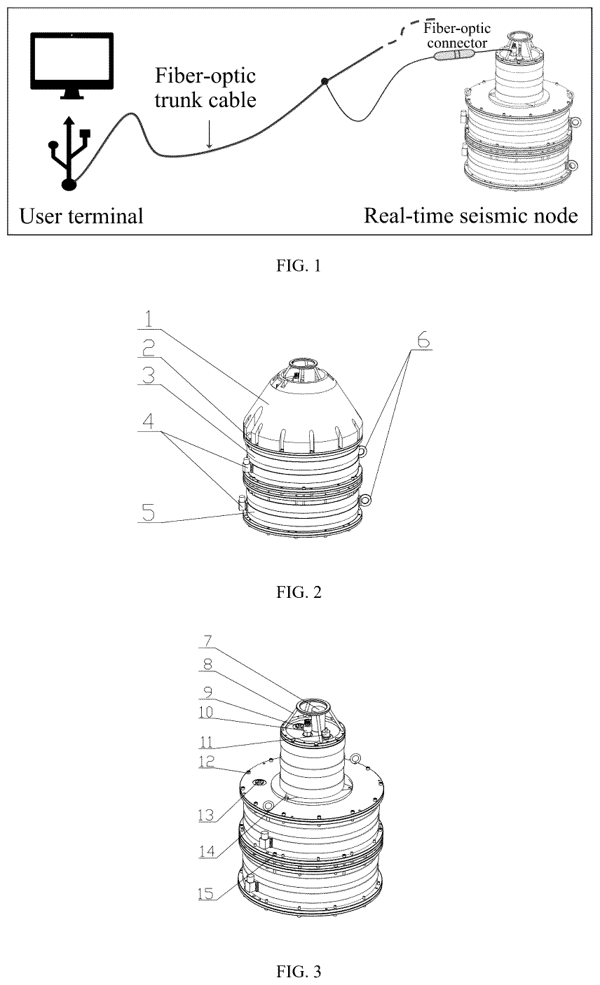

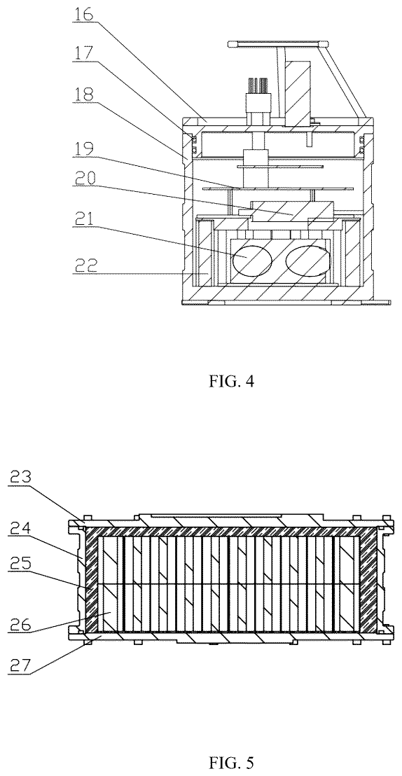

Please refer to FIGS. 1 to 5, a fiber-optic transmission-based real-time ocean bottom seismic node includes a seismic acquisition compartment and a battery compartment.

The seismic acquisition compartment includes seismometer compartment body 18, compressed O-ring 17, and seismometer compartment sealing cover 16. An airtight space is formed inside the seismometer compartment body 18 by the seismometer compartment sealing cover 16 via the compressed O-ring 17. A bottom of the seismometer compartment body 18 is provided with a three-component seismometer to acquire ocean bottom seismic data. A top of the seismometer compartment body 18 is provided with optical-electrical conversion connector 11. The three-component seismometer communicates with a fiber-optic trunk cable of a user terminal via the optical-electrical conversion connector 11. A small number of rechargeable batteries 22 for temporary testing are arranged around the three-component seismometer (three-component geophone 21). The geophone 21 is fixed to optical-electrical conversion module 20 and acquisition circuit board 19.

The battery compartment is detachably connected to the seismic acquisition compartment and configured to supply power to the three-component seismometer.

There is at least one battery compartment. Battery compartments are detachably connected to each other through battery compartment connecting screw 15. The quantity of the battery compartment is selectable for assembly according to actual exploration needs. The seismic acquisition compartment is fixed to a top surface of battery compartment upper cover 23 through bottom triangular positioning plate 14. Buoyancy material 1 is disposed around the seismic acquisition compartment.

Furthermore, top protective cover 8 is fixed to the seismometer compartment sealing cover 16. The seismometer compartment sealing cover 16 is provided with a plurality of accessory mounting holes. The optical-electrical conversion connector 11, hydrophone 7, data cable bulkhead penetrator 10, and seismometer compartment air valve 9 are fixed to the seismometer compartment sealing cover 16 via the accessory mounting holes.

The battery compartment includes the battery compartment upper cover 23, battery compartment base 27, and battery compartment body 24. The battery compartment upper cover 23 and the battery compartment base 27 compress sealing rings at two ends of the battery compartment body 24 respectively to form an airtight space inside the battery compartment body 24. The rechargeable battery 26 is disposed inside the battery compartment body 24. Insulating filling liquid 25 is filled around the rechargeable battery 26 to resist an external pressure. The battery compartment is further provided with battery compartment air valve 13.

In an embodiment of the present disclosure, a single real-time seismic node is located at a branch cable of the fiber-optic trunk cable and connected to the fiber-optic trunk cable via the fiber-optic connector. The other end of the fiber-optic trunk cable is provided with the shore-based user terminal. The external structure of a single fiber-optic transmission-based real-time ocean bottom seismic node apparatus includes a pressure-resistant seismic acquisition compartment as well as upper and lower flanges. A usage process of the apparatus is as follows. After debugging of the single independent real-time seismic node is completed, the external reserved fiber-optic connector is connected to the fiber-optic trunk cable. The shore-based user terminal remotely controls the seismic node to enter a working status. The compartment pressure and seismic data acquisition of the seismic node are debugged for normal operation. After the seismic node becomes operational, the apparatus is deployed to a preselected ocean bottom position using a vessel to realize real-time seismic data acquisition and transmission at the node. The shore-based user terminal saves seismic data in real time.

To meet high-sensitivity seismic data acquisition requirements, all compartment bodies of the apparatus satisfy the technical design of whole-apparatus strong coupling and low noise interference. The compartment body manufacturing adopts forged punching followed by rolling forming processes. The heating forging process significantly improves compartment body microstructure and mechanical properties. Due to low material costs, energy consumption, and comprehensive costs, the design ensures economic viability for mass production of compartment bodies and guarantees batch engineering of real-time seismic node apparatuses in later stages. Different functional accessory mounting holes are reserved on the top of the compartment body for mounting the hydrophone, the sealed connector, observation holes, etc. All mounting holes withstand pressure intensity at a 1,000-meter water depth.

The upper flange design adopts a fan-shaped structure to realize protective functions for the connector and the hydrophone while maintaining connection convenience with other structures. The flange reserves surplus space and adopts a high-strength material to ensure whole-apparatus handling. This structural design neither affects uniform internal layout of the entire apparatus nor compromises operational convenience during marine deployment/retrieval.

The independent battery compartment body and seismic acquisition compartment body are fixedly connected via a fixing threaded hole in the lower flange. The seismic acquisition compartment body internally integrates a digital acquisition device, an omnidirectional high-sensitivity geophone, a network communication module, a global positioning system (GPS) module, and an electronic compass. The three-component seismometer is formed by equipping an omnidirectional geophone with a self-developed frequency-expanding circuit board. This design ensures flat frequency response curves, high stability, and enhanced sensitivity across a wide frequency band.

The electronic circuit and software architecture adopt a relatively mature data acquisition solution of a self-floating OBS. The hardware/software solution migrates the original mature ocean bottom seismic acquisition system based on an ARM7-based microcontroller to a Cortex-M3-based microcontroller system with higher performance and lower power consumption. Meanwhile, the real-time data transmission module is upgraded to first send data to the optical-electrical conversion module via a network protocol, which converts the data into an optical signal for long-distance transmission via an optical fiber. This electronic circuit and software architecture solution inherits previously successfully developed and batch-applied OBS systems. It shortens development cycles, reduces development risks, saves development costs, upgrades overall apparatus performance, and ensures technological advancement of the real-time seismic node apparatus.

It should be noted that the usage process of the ocean bottom seismic node of the present disclosure is as follows.

The external reserved fiber-optic connector of a single independent real-time seismic node is connected to the fiber-optic trunk cable. The shore-based user terminal remotely controls the seismic node to enter a working status. The compartment pressure and seismic data acquisition of the seismic node are debugged for normal operation. If an abnormality occurs, instrument maintenance is performed. If the status is normal, the single real-time seismic node apparatus is additionally connected to the fiber-optic trunk cable using a Kevlar rope. By leveraging the Kevlar rope, the seismic node is deployed to a preselected ocean bottom position via a vessel to realize real-time seismic data acquisition and transmission at the node. The shore-based user terminal saves seismic data in real time. After data acquisition is completed, the entire fiber-optic trunk cable is retrieved. Due to the added buoyancy material, the single real-time seismic node has low underwater weight. Therefore, the seismic node can be dragged to the sea surface directly by retrieving the fiber-optic trunk cable. After reaching the sea surface, the single real-time seismic node is retrieved to a deck using the Kevlar rope on the seismic node.

Since ocean bottom seismic signals are acquired on the seabed, the raw signals include considerable noise due to environmental factors. These noises originate from complex sources, mainly including natural noises and biological noises. For example, wave slapping, tidal variations, and marine biological activities (such as whale calls, fish school movements, etc.) can all generate noise. These noises have wide frequency ranges and likely overlap with seismic signals, interfering with seismic signal identification.

Therefore, the present disclosure employs a noise denoising module configured to denoise the acquired ocean bottom seismic signal data and obtain denoised ocean bottom seismic signal data.

Furthermore, the noise denoising module includes a signal decomposition module, a threshold construction module, a processing function construction module, a thresholding module, and a denoising module.

The signal decomposition module is configured to perform wavelet transform on the ocean bottom seismic signal data to obtain a wavelet coefficient.

The threshold construction module is configured to calculate a denoising threshold based on a mean of the wavelet coefficient.

In the threshold construction module, the denoising threshold is constructed as follows:

$$\{ \begin{matrix}\frac{{( {w}_{i , j - μ} )}^{2}}{{2}_{σ}^{2}} \\ {T}_{j} = ke \\ {D}_{j} = \frac{{σ}_{0}^{2}}{σ}\end{matrix}$$

where, Tⱼ denotes a denoising threshold at a j-th decomposition scale; k denotes a preset parameter; w_{i,j} denotes a j-th wavelet coefficient at an i-th decomposition scale; μ denotes a mean of the wavelet coefficient at the i-th decomposition scale; σ denotes a standard deviation of the j-th wavelet coefficient it at the i-th decomposition scale, σ₀=median(|w_{i,j}|)/0.6745; and median denotes a median of the wavelet coefficient at the i-th decomposition scale.

In the present disclosure, the denoising threshold varying with wavelet decomposition scales is constructed based on the mean and standard deviation of the wavelet coefficients at different decomposition scales. This enables adaptive transformation of wavelet coefficients at each scale, enhances detail features across scales, and suppresses various noises in seismic monitoring signals.

The processing function construction module is configured to construct a wavelet coefficient processing function based on the denoising threshold. The wavelet coefficient processing function is:

$${\hat{w}}_{j , k} = \{ \text{} \begin{matrix}{w}_{j , k} - \frac{{T}_{j} ( α - {e}^{- β \frac{\vert {w}_{j , k} \vert - {T}_{i}}{{T}_{j}} )} sign ( {w}_{j , k} )}{α + {e}^{- β \frac{\vert {w}_{j , k} \vert - {T}_{j}}{{T}_{j}}}} & \vert {w}_{j , k} \vert > {T}_{j} ( 1 - \frac{In α}{β} ) \\ {w}_{j , k} - \frac{{T}_{j} ( α + 1 ) ( α - {e}^{- β \frac{\vert {w}_{j , k} \vert - {T}_{j}}{{T}_{j}}} ) sign ( {w}_{j , k} )}{( α - 1 ) ( α + {e}^{- β \frac{\vert {w}_{j , k} \vert - {T}_{j}}{{T}_{j}}} )} & {T}_{j} < \vert {w}_{j , k} \vert \leq {T}_{j} ( 1 - \frac{In α}{β} ) \\ 0 & \vert {w}_{j , k} \vert \leq {T}_{j}\end{matrix}$$

where, ŵ_{j,k} denotes the denoised wavelet coefficient; w_{j,k} denotes a k-th wavelet coefficient at the j-th decomposition scale; α denotes a first adjustable coefficient; and β denotes a second adjustable coefficient.

Traditional threshold functions include hard threshold functions and soft threshold functions. Traditional hard and soft threshold functions can denoise to a certain extent but have shortcomings. The hard threshold function can preserve local information of original signals, but a jump occurs at threshold T, causing reconstructed signals to oscillate and exhibit pseudo-Gibbs phenomena. The soft threshold function overcomes the discontinuity issue of the hard threshold function, and signals denoised by the soft threshold function become relatively smooth. However, a constant deviation exists between wavelet coefficients estimated by the soft threshold function, leading to partial loss of reconstructed signals.

In the present disclosure, the wavelet coefficient processing function lies between hard and soft threshold functions, allows switching by adjusting α and β, increasing flexibility in threshold function usage. The denoising function is a continuous odd function on (−∞,+∞) and approximates a soft threshold function when |w_{j,k}|→∞. When |w_{j,k}|>T, since

$$( α - {e}^{- β \frac{\vert {w}_{j , k} \vert - T}{T}} ) / ( α + {e}^{- β \frac{\vert {w}_{j , k} \vert - T}{T}} ) < 1 ,$$

the constant deviation issue of the soft threshold function is effectively solved when the wavelet coefficients are large, making reconstructed seismic signals closer to actual values.

In practical applications, the present disclosure can evaluate a signal-to-noise ratio (SNR) of the denoised seismic signal. When the SNR is outside a preset range, α and β are readjusted until the SNR of the seismic signal falls within a target range.

The thresholding module is configured to apply the wavelet coefficient processing function to the wavelet coefficient for thresholding to obtain a denoised wavelet coefficient. The denoising module is configured to reconstruct the denoised wavelet coefficient and obtain the denoised ocean bottom seismic signal data.

In the present disclosure, the three-component seismometer is connected to the user terminal via the optical fiber to enable high-speed data transmission, ensuring real-time transmission of seismic data to the user terminal. In addition, the present disclosure performs denoising on the seismic signal to improve data quality, facilitating long-term monitoring by researchers.

The above are merely specific implementations of the present disclosure, but the protection scope of the present disclosure is not limited thereto. Any technical solution for modification or replacement easily conceived by those skilled in the art within the technical scope of the present disclosure should fall within the protection scope of the present disclosure. Therefore, the protection scope of the present disclosure shall be subject to the protection scope of the claims.

1. A fiber-optic transmission-based real-time ocean bottom seismic node, comprising:
a seismic acquisition compartment, comprising a seismometer compartment body, a compressed O-ring, and a seismometer compartment sealing cover, wherein a first airtight space is formed inside the seismometer compartment body by the seismometer compartment sealing cover via the compressed O-ring; a bottom of the seismometer compartment body is provided with a three-component seismometer for acquiring ocean bottom seismic signal data, and a top of the seismometer compartment body is provided with an optical-electrical conversion connector; and the three-component seismometer communicates with a fiber-optic trunk cable of a user terminal via the optical-electrical conversion connector;
a battery compartment, detachably connected to the seismic acquisition compartment and configured to supply power to the three-component seismometer; and
a noise denoising module, configured to denoise the ocean bottom seismic signal data and obtain denoised ocean bottom seismic signal data;
wherein, the noise denoising module comprises:
a signal decomposition module, configured to perform wavelet transform on the ocean bottom seismic signal data to obtain a wavelet coefficient;
a threshold construction module, configured to calculate a denoising threshold based on a mean of the wavelet coefficient;
wherein, in the threshold construction module, the denoising threshold is constructed as follows:
$$\{ \begin{matrix}{T}_{j} = {ke}^{\frac{{( {w}_{ij} - μ )}^{2}}{2 {σ}^{2}}} \\ {D}_{j} = \frac{{σ}_{0}^{2}}{σ}\end{matrix}$$
wherein, Tⱼ denotes a denoising threshold at a j-th decomposition scale; k denotes a preset parameter; w_{i,j} denotes a j-th wavelet coefficient at an i-th decomposition scale; μ denotes a mean of the wavelet coefficient at the i-th decomposition scale; σ denotes a standard deviation of the j-th wavelet coefficient at the i-th decomposition scale, σ₀=median(|w_{i,j}|)/0.6745; and median denotes a median of the wavelet coefficient at the i-th decomposition scale;
a processing function construction module, configured to construct a wavelet coefficient processing function based on the denoising threshold;
a thresholding module, configured to apply the wavelet coefficient processing function to the wavelet coefficient for thresholding to obtain a denoised wavelet coefficient;
wherein, in the thresholding module, the wavelet coefficient processing function is:
$${\hat{w}}_{j , k} = \{ \text{} \begin{matrix}{w}_{j , k} - \frac{{T}_{j} ( α - {e}^{- β \frac{\vert {w}_{j , k} \vert - {T}_{i}}{{T}_{j}} )} sign ( {w}_{j , k} )}{α + {e}^{- β \frac{\vert {w}_{j , k} \vert - {T}_{j}}{{T}_{j}}}} & \vert {w}_{j , k} \vert > {T}_{j} ( 1 - \frac{In α}{β} ) \\ {w}_{j , k} - \frac{{T}_{j} ( α + 1 ) ( α - {e}^{- β \frac{\vert {w}_{j , k} \vert - {T}_{j}}{{T}_{j}}} ) sign ( {w}_{j , k} )}{( α - 1 ) ( α + {e}^{- β \frac{\vert {w}_{j , k} \vert - {T}_{j}}{{T}_{j}}} )} & {T}_{j} < \vert {w}_{j , k} \vert \leq {T}_{j} ( 1 - \frac{In α}{β} ) \\ 0 & \vert {w}_{j , k} \vert \leq {T}_{j}\end{matrix}$$
wherein, ŵ_{j,k} denotes the denoised wavelet coefficient; w_{j,k} denotes a k-th wavelet coefficient at the j-th decomposition scale; and α and β denote adjustable coefficients; and
a denoising module, configured to reconstruct the denoised wavelet coefficient and obtain the denoised ocean bottom seismic signal data.

2. The fiber-optic transmission-based real-time ocean bottom seismic node according to claim 1, wherein a top protective cover is fixed to the seismometer compartment sealing cover; the seismometer compartment sealing cover is provided with a plurality of accessory mounting holes; and the optical-electrical conversion connector, a hydrophone, a data cable bulkhead penetrator, and a seismometer compartment air valve are fixed to the seismometer compartment sealing cover via the plurality of accessory mounting holes.

3. The fiber-optic transmission-based real-time ocean bottom seismic node according to claim 2, wherein the battery compartment comprises a battery compartment upper cover, a battery compartment base, and a battery compartment body; the battery compartment upper cover and the battery compartment base compress sealing rings at two ends of the battery compartment body respectively to form a second airtight space inside the battery compartment body; and a rechargeable battery is disposed inside the battery compartment body.

4. The fiber-optic transmission-based real-time ocean bottom seismic node according to claim 3, wherein an insulating filling liquid is filled around the rechargeable battery to resist an external pressure.

5. The fiber-optic transmission-based real-time ocean bottom seismic node according to claim 4, wherein the seismic acquisition compartment is fixed to a top surface of the battery compartment upper cover via a bottom triangular positioning plate; and a buoyancy material is disposed around the seismic acquisition compartment.

6. The fiber-optic transmission-based real-time ocean bottom seismic node according to claim 5, wherein the battery compartment is further provided with a battery compartment air valve.

7. The fiber-optic transmission-based real-time ocean bottom seismic node according to claim 1, wherein there is at least one battery compartment; and battery compartments are detachably connected to each other via a battery compartment connecting screw.
